(19) United States
(12) Patent Application Publication
(10) Pub. No.: US 2013/0231091 A1
(43) Pub. Date: Sep. 5, 2013

(54) APPARATUS SYSTEM AND METHOD FOR TRANSMITTING CODED MESSAGES ELECTRONICALLY

(71) Applicant: ISAAC S. DANIEL, MIRAMAR, FL (US)

(72) Inventor: ISAAC S. DANIEL, MIRAMAR, FL (US)

(21) Appl. No.: 13/532,615

(22) Filed: Jun. 25, 2012

Related U.S. Application Data
(63) Continuation-in-part of application No. 29/397,354, filed on Jul. 14, 2011, now Pat. No. D672275.
(60) Provisional application No. 61/500,514, filed on Jun. 23, 2011.
(60) Provisional application No. 61/562,905, filed on Nov. 22, 2011.

(51) Int. Cl. H04W 4/12

(52) U.S. Cl. 455/412.2; 455/412.1

(57) ABSTRACT

The present invention relates generally to an apparatus, system and method of transmitting coded messages electronically using a mobile communication device to transmit coded messages identifiable by pre-programmed or programmable buttons associated with icons corresponding to the coded messages being transmitted.

### PRIORITY CLAIM

This patent application is a continuation in part of, and claims priority to U.S. Provisional Continuation In Part Patent Application Ser. No. 61/500,514 titled “An Apparatus For Transmitting Coded Messages Electronically” filed on Jun. 23, 2011 and United States Design Patent Application Ser. No. 29/397,352 titled: “A Communication Device For Transmitting Coded Messages” filed on Jul. 14, 2011; U.S. Provisional Application Ser. No. 61/562,905 titled “A Method of Transmitting Coded Messages And Providing for Calendaring Events” filed Nov. 22, 2011. The entire disclosures of the afore-mentioned applications are incorporated by reference as if fully stated herein.

### FIELD OF THE INVENTION

The present invention relates generally to an apparatus, system and method of transmitting coded messages electronically using a mobile communication device to transmit coded messages identifiable by pre-programmed or programmable buttons associated with icons corresponding to the coded messages being transmitted.

### DESCRIPTION OF THE PRIOR ART

Although we are all aware of the dangers of driving and texting, a small minority still persists in engaging in this dangerous practice either out of perceived necessity or fear of missing an important call or message. Many states have cracked down on this practice enforcing traffic laws by issuing traffic tickets, but still the problem persists. Several mobile communicating devices, e.g. cellular phones, include voice activation options for dialing or answering calls, but not all phones include this option and/or not all users are fully conversant with this functionality. Notwithstanding, voice activation does not necessarily solve the underlying problem of trying to communicate a short message to callers in a quick, efficient and safe manner.

Individuals also face similar challenges in varied social settings where protocol dictates that phone conversations are kept to an absolute necessity, e.g. in a meeting or in attendance at a concert. Yet in an effort not to be discourteous, many will choose to answer the phone and risk sounding abrupt to communicate their acknowledgement of the caller but inability to engage in a full blown conversation because they are otherwise engaged, e.g. at a concert.

Thus, it would be useful to have an apparatus, system and method of transmitting short messages in instances when a full blown conversation is not a feasible option, in a quick and efficient manner. This invention satisfies these long felt needs in a new and novel manner and solves the foregoing problems that the prior art has been unable to resolve.

### SUMMARY

A primary object of the present invention is to provide an apparatus, system and method for transmitting messages using a mobile communication device that overcomes the limitations of the prior art.

Yet another object of the present invention is to provide a system and method wherein a user may selectively transmit a message using any one or more of the programmed keys to transmit a message to one or more recipients.

An object of the present invention is to provide a system and method for transmitting coded messages using a mobile communication device that overcomes the limitations of the prior art.

Another object of the present invention is to provide a system and method for sending short coded messages via mobile communication devices using pre-programmed and/or programmable buttons.

Yet another object of the invention is to provide the means for users to customize a coded message for a particular icon.

Another object of the invention is to provide the means for users to customize and edit the coded messages associated with particular icons.

Yet another object of the invention is to provide a system and method for correlating short coded messages with display icons which can be used to transmit at least one coded message to at least one or a plurality of message recipients.

Still yet another object of the invention is to allow users to customize the short coded messages being transmitted to communicate in a language of their choice.

Another object of the present invention is to provide a method wherein a user may selectively transmit at least one or more messages to one or a plurality of message recipients using any one or more of the pre-programmed or programmable buttons.

Another object of the present invention is to provide an apparatus, comprising of: a mobile communication device, which is a network enabled computer device configured for communicating over a communication network; at least on icon imprinted on at least one programmable button positioned on an electronic keyboard wherein the icon corresponds to a coded message for transmission to a message recipient; communications means electronically connected to a computer processor positioned within the mobile communication device; computer executable instruction code readable by the computer processor and operative to perform any one or more of the following: receive selection of at least one icon for transmission of a corresponding coded message to at least one or more message recipient; convert the selected at least one icon into the corresponding coded message; display the converted coded message on the mobile communication device's at least one displaying means; display list of the at least one or more message recipient for the converted coded message; receive selection of the at least one or more message recipient; or transmit the converted coded message to the at least one or more message recipient.

In some embodiments, the computer executable instruction code readable by the computer processor are further operative to perform any one or more of the following: activate the mobile communication device for the receipt or transmission of electronic communications; receive incoming electronic communications from a sender; push notification of the incoming electronic communications to the mobile communication device's displaying means; display confirmation of transmission of the coded message; or respond to the incoming electronic communications in any one or more of the following manner: voice, text or termination of the incoming communication. Incoming electronic communications may include any one or more of the following: text, call, or data. Push notification further comprises notifying the user of the incoming electronic communications by any one or more of the following means: audio, text or graph.

In some embodiments, the apparatus further comprises of a coded message application comprising of computer executable instruction code readable by the computer processor that are operative to perform any one or more of the following: launch an application program for transmitting the at least one coded message to the at least one message recipient; or display a plurality of icons on the mobile communication device's at least one displaying means.

In some embodiments, the invention includes a virtual touch-screen keyboard configured to receive the selection of the at least one icon for transmission of the corresponding coded message to the at least one or more message recipient. Displaying means as used herein includes any one of the following: a liquid crystal display screen, a light emitting diode display, touchpad or touch screen display. Communication means are operative to transmit or receive electronic communications.

Another object of the present invention is to provide a system and method comprising of: a mobile communication device, which is a network enabled computer device configured for communicating over a communication network; a computer processor positioned within the mobile communication device; computer executable instruction code readable by the mobile communication device's computer processor and operative to perform any one or more of the following: receive selection of at least one icon for transmission of a corresponding coded message to at least one message recipient; convert the selected at least one icon into the corresponding coded message; display the converted coded message on the mobile communication device's at least one displaying means; display list of the at least one message recipient for the converted coded message; receive selection of the at least one message recipient; or transmit the converted coded message to the at least one message recipient.

In some embodiments, computer executable instruction code readable by the computer processor are further operative to perform any one or more of the following: activate the mobile communication device for the receipt or transmission of electronic communications; receive incoming electronic communications from a sender; push notification of the incoming electronic communications to the mobile communication device's displaying means; display confirmation of transmission of the coded message; or respond to the incoming electronic communications in any one or more of the following manner: voice, text or termination of the incoming communication. Incoming electronic communications may include any one or more of the following: text, call, or data. The incoming electronic communications may be responded to by any one or more of the following manner: voice, text or termination of the incoming electronic communications. The at least one icon corresponds to at least one programmable button positioned on the mobile communication device.

For a further and more fully detailed understanding of the present invention, various objects and advantages thereof, reference is made to the following detailed description and the accompanying drawings.

Additional objectives of the present invention will appear as the description proceeds.

The foregoing and other objects and advantages will appear from the description to follow. In the description, references are made to the accompanying drawings, which forms a part hereof, and in which is shown by way of illustration specific embodiments in which the invention may be practiced. These embodiments will be described in sufficient detail to enable those skilled in the art to practice the invention, and it is to be understood that other embodiments may be utilized and that structural changes may be made without departing from the scope of the invention. In the accompanying drawings, like reference characters designate the same or similar parts throughout the several views. The following detailed description is, therefore, not to be taken in a limiting sense, and the scope of the present invention is best defined by the appended claims.

### BRIEF DESCRIPTION OF THE DRAWINGS

Further objectives and advantages of the present invention may be derived by referring to the detailed description and claims when considered in connection with the Figures, wherein like reference numbers refer to similar items throughout the Figures.

FIGS. 1A-1C are exemplary embodiments of the system according to one embodiment.

FIG. 2 shows an exemplary embodiment of the code mobile application according to one embodiment.

FIG. 3 is a sample flowchart of block diagram of an exemplary method according to one embodiment of the invention.

FIG. 4 describes a sample flowchart of a block diagram of an exemplary method of transmitting at least one coded message according to another embodiment.

FIG. 5 describes a sample flowchart of a block diagram of an exemplary method of calendaring an event.

FIG. 6 is a block diagram representing an apparatus according to various embodiments.

### DETAILED DESCRIPTION OF PREFERRED EMBODIMENTS

The following discussion describes in detail an embodiment of the various methods for transmitting coded messages as described below. However, this discussion should not be construed, as limiting the invention to those particular embodiments, as practitioners skilled in the art will appreciate that an apparatus, system and method may vary as to configuration and as to details of the parts, and that a method may vary as to the specific steps and sequence, without departing from the basic concepts as disclosed herein. Similarly, the elements described herein may be implemented separately, or in various combinations without departing from the teachings of the present invention. For definition of the complete scope of the invention, the reader is directed to appended claims. Turning now descriptively to the drawings, in which similar reference characters denote similar elements throughout the several views.

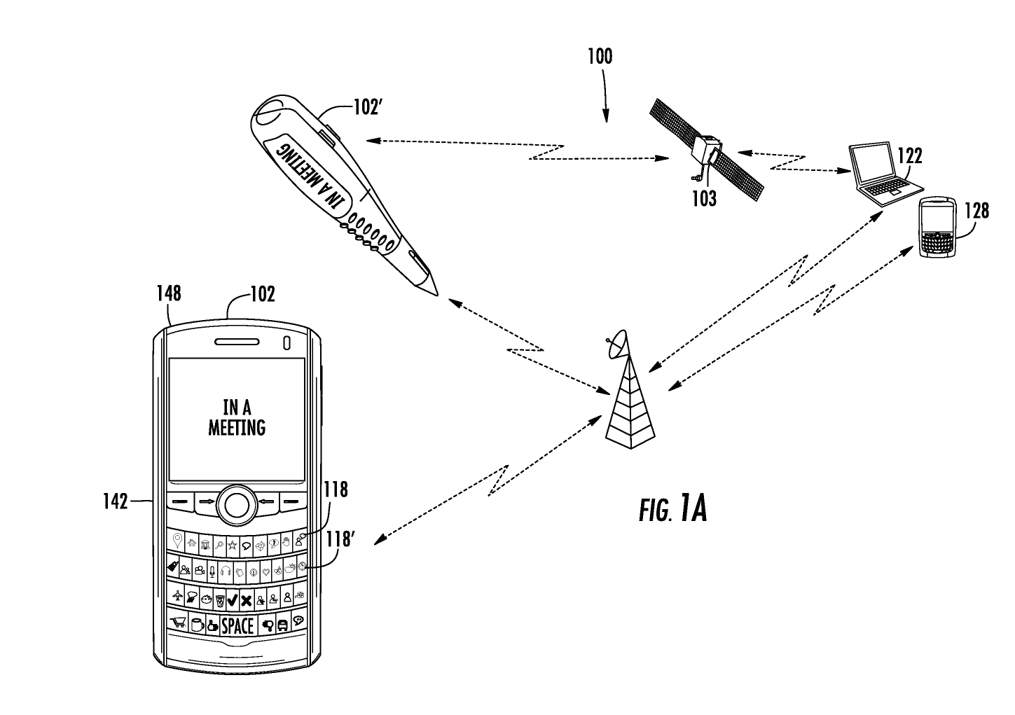

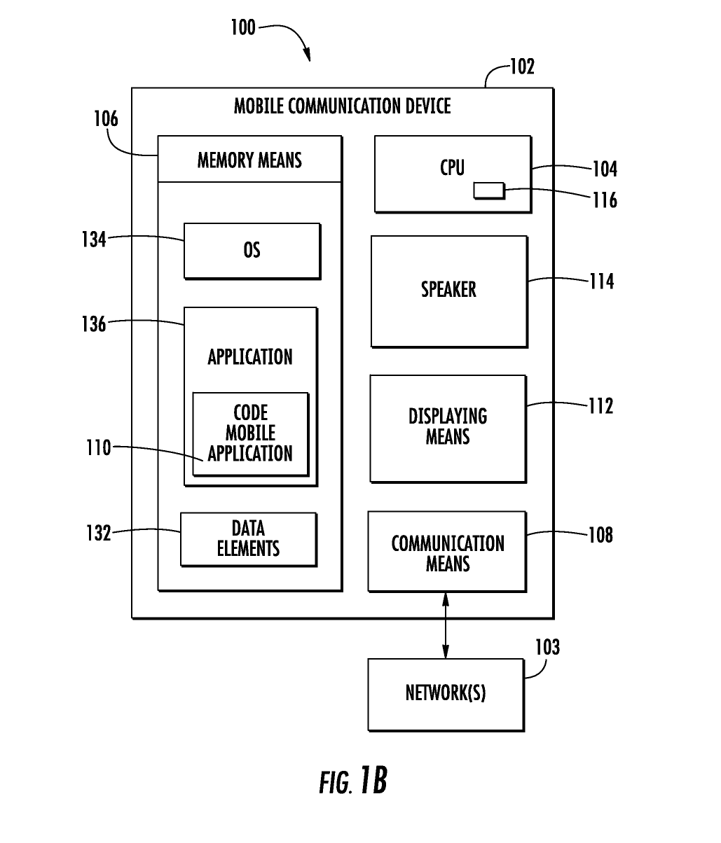

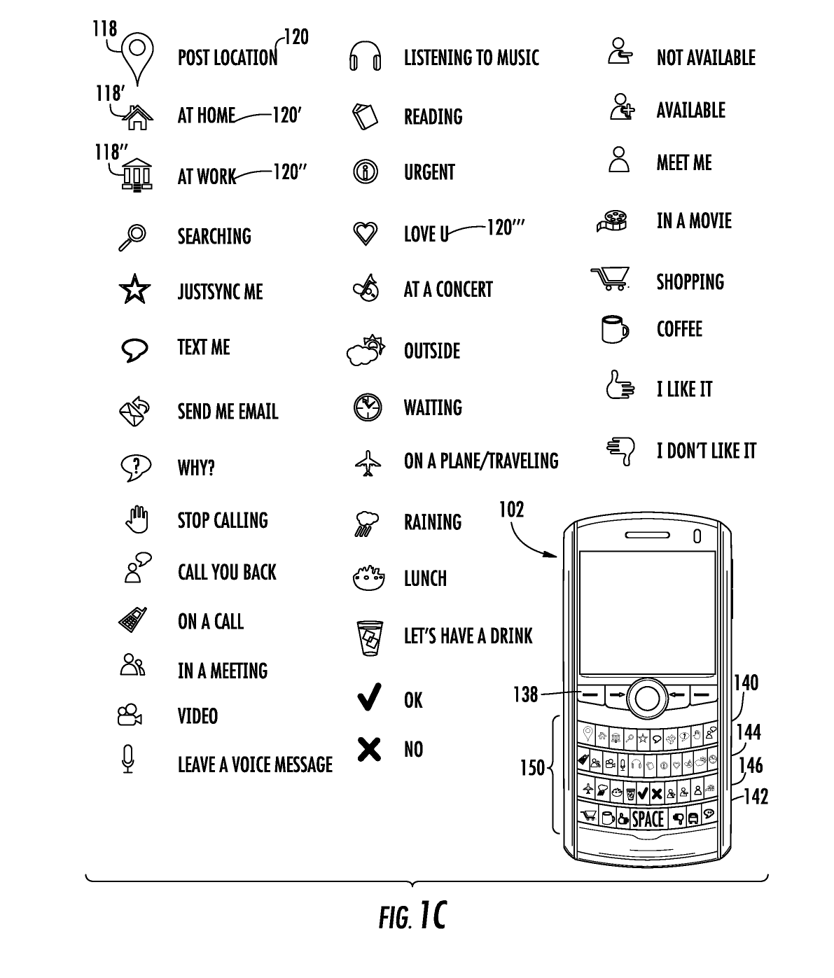

FIG. 1A is an illustrative view of the system 100 of the invention according to one embodiment of the present invention. System 100 includes an exemplary mobile communication device 102 whereby mobile communication device 102 may be any type of a network enabled computer device configured with means for communicating wirelessly and/or wired with other mobile communication devices 102, 102′, such as but not limited to, cellular phones (e.g., an iPhone, Android, Palm, Blackberry, or any “smart phone” as are generally known and used in the arts), location-aware portable phones (such as GPS), a personal computer, server computer, or laptop, or netbook computer, a personal digital assistant (“PDA”) such as a Palm-based device or Windows CE device, a laptop computer, a tablet, personal computer, a portable screen, a portable processing device and/or any other portable device capable of communicating wirelessly over a computer network 103, local area network, wide area network such as the Internet, or any other type of network device that may communicate over a network.

As shown in FIG. 1B, mobile communication device 102 may include various hardware components, e.g. a computer processor 104, memory means 106, and one or more communication means 108.

Computer processor 104 may be any type of processor, such as, but not limited to, a central processing unit (CPU), a microprocessor, a video processor, a front end processor, a coprocessor, a single-core processor, a multi-core processor, as well as any known computer processor 104 that's used in the arts. Central processor 104 may be programmed to activate a code mobile application (“app”) 110 for managing the incoming electronic transmissions and receiving user supplied coded messages for transmissions to select message recipients, whereby exemplary notifications of incoming transmissions or coded messages to be transmitted are displayed on the mobile communication device's displaying means 112 in for example a graphical, audio, and/or text format. Mobile communication device 102 also includes a speaker 114 for publishing the various functions being performed in audio. Speaker 114 may be any kind of speaker that is well known and used in the arts.

Computer processor 104 is housed within the mobile communication device 102 and includes computer executable instruction code 116, where the computer executable instruction code 116 are operative to perform all the necessary functions for the system 100 and methods disclosed herein, including but not limited to launching the code mobile app 110.

Computer executable instruction code 116 may be loaded directly on the mobile communication device's processor 104, or may be stored in mobile communication device's memory means 106 such as, computer readable media that includes but is not limited to, a hard drive, a solid state drive, a flash memory, random access memory, CD-ROM, CD-R, CD-RW, DVD-ROM, DVD-R, DVD-RW, and the like. The computer executable instruction code 116 may be any type of computer executable instruction code 116, which may be in the form of a computer program, the program being composed in any suitable programming language or source code, such as C++, C, JAVA, JavaScript, HTML, XML, and other programming languages.

Computer executable instruction code 116 are operative to perform any and all the necessary functions for the system 100 and methods disclosed herein, which may include any one or more of the following: launch the code mobile application program 110 on the at least one mobile communication device 102; receive selection of at least one icon 118 for transmission of a corresponding coded message 120 to at least one or more message recipients 122, 122′; convert the selected at least one icon 118 into the corresponding coded message 120; display the converted coded message 120 on the mobile communication device's at least one displaying means 112; receives the instruction to transmit the coded message 120; display list 124 of the at least one or more message recipients 122, 122′ for the converted coded message 120; receive selection of the at least one or more message recipient 122, 122′; transmit the converted coded message 120 to the at least one or more message recipient 122, 122′; and the like.

In some embodiments, computer executable instruction code 116 are operative to perform any or more of the following: activate the mobile communication device 102 for the receipt or transmission of electronic communications 126; receive at least one or more incoming electronic communications 126, 126′ from at least one sender 128; push notification of the incoming electronic communications 126 to the mobile communication device's displaying means 112; display confirmation of transmission of the coded message 120; or respond to the incoming electronic communications 126 in any one or more of the following manner: voice, text or termination of the incoming communication 126.

Displaying means 112 may include any kind of displaying means 112, such as, but not limited to: a liquid crystal display (“LCD”) screen, a light emitting diode (“LED”) display, touchpad or touch screen display, and/or any other means known in the arts for emitting a visually perceptible output. Mobile communication device's processor 104 is in electronic communication with its displaying means 112. In other embodiments, displaying means 112 is wirelessly connected to processor 104. Displaying means 112 may include a control means, such as, but not limited to, a touch screen, a stylus, and the like. In some embodiments, display means may be electronically connected to a mobile communication device according to the hardware and software protocols that are known and used in the arts. Processor 104 controls the mobile communication device's displaying means 112, which is configured for displaying notifications of incoming transmissions; displaying the converted icon's coded message 118 on the at least one displaying means 112; displaying confirmation of transmission of the coded message 118; and/or displaying one or more electronic addresses 129, 129′ for a plurality of message recipients 122, 122′ of the at least one coded messages 120, 120′ being transmitted and/or the like.

Mobile communication device 102 also includes communication means 108 for transmitting and receiving coded messages 120, 120′ to or from one or more recipients 122, 122′. A recipient 122 may include a caller or one or more message recipients 122, 122′ that the user selects to receive the coded messages 120, 120′.

Communication means 108 is electronically connected to the computer processor 104. In the case of electronic connections, the electronic connections may be wired and/or wireless. In some embodiments, communication means 108 may be a wireless communication means 108, which employ short range wireless protocol, such as, but not limited to, a radio frequency transceiver with integrated radio and shared antenna, a radio frequency receiver, and/or a radio frequency transmitter. In embodiments where the wireless communication means 108 is a radio frequency receiver, the radio frequency receiver may be any type of radio frequency receiver, including, but not limited to, a positioning system receiver, such as a global positioning system receiver and a local positioning system receiver, such as a Wi-Fi positioning system receiver. In other embodiments, the communication means 108 may employ wireless protocols like Blue Tooth, ZigBee, 702.11 series, or a wireless modem, such as, but not limited to, a global system for mobile communications (GSM) modem, or any other short range wireless protocol that is well known and used in the arts and other future short range wireless protocol suitable for transmitting and receiving data. Communication means 108 are operative to transmit or receive electronic communications, i.e. data, text, pictures, video, streaming data and the like via a short range wireless protocol, such as, but not limited to, a radio frequency receiver, a radio frequency transmitter, or a radio frequency transceiver. In some embodiments, the communication means 108 are in mating engagement with an autonomous power source 130, e.g. a rechargeable battery.

Mobile communication device 102 may include one or more memory means 106 electronically connected to the at least one computer processor 104. In the case of electronic connections, the electronic connections may be wired and/or wireless connections. Memory means 106 may comprise of a storage device and may include memory, such as, but is not limited to, read-only memory, such as CD-ROMs, DVDs, floppy disks, and the like, read and write memory, such as a hard drive, floppy disc, CD-RW, DVD-RW, solid state memory, such as solid state hard drives, flash memory, and the like, and random access memory. Memory means 106 may be used to store information, such as electronic addresses for message recipients 122, 122′, coded messages 120, 120′ associated with icons 118, 118′, transmitted coded messages 120, 120′ and the like, which may be stored in one or more data elements 132. Electronic addresses 129, 129′ include, but are not limited to, name, address, telephone number, email address, internet protocol address and the like. Stored information may be retrieved from memory means 106 using the computer processor 104.

Mobile communication device 102 also includes software components, e.g. an operating system (“OS”) 134 that manages the hardware resources and other software components, by scheduling the various tasks to be accomplished by the processor 104 or input and output and memory allocation in the memory means 106 and the like. OS 134 acts as an intermediary between programs and the hardware components, and comprises of computer executable instruction code 116 to accomplish the various scheduling tasks. OS 134 may comprise of any one of the following operating systems, that may include but is not limited to ANDROID, BSD, IOS, GNU/LINUX, MAC OS X, MICROSOFT WINDOWS, WINDOWS PHONE, and IBM z/OS. In the exemplary mobile communication device 102, OS 134 resides in the memory means 106 as shown in FIG. 1B.

In some embodiments, system 100 may include a code mobile app 110, for managing the incoming electronic transmissions and receiving user supplied coded messages 120, 120′ for transmissions to select message recipients 122, whereby exemplary notifications of incoming transmissions or coded messages 120, 120′ to be transmitted are displayed on the mobile communication device's displaying means 112 in for example a graphical, audio, and/or text format. The code mobile app 110 may reside with applications 136 that are stored in the memory means 106. In some embodiments, code mobile app 110 once activated by the activation button 138 intercepts incoming electronic communication 126 to allow code mobile app 110 to process the response via either voice, a coded message 120, other text or termination of the incoming electronic communication 126.

The app 110 may be any type of software application, such as a standalone application designed to run on a mobile platform, including an operating system 134, such as IOS™, ANDROID™, WINDOWS MOBILE™, BLACKBERRY™, and the like. Code mobile app 110 may be operative for an iPhone, other “smart phones”, mobile communication devices, cellular phones, PDAs, GPS or any other mobile communication devices 102 capable of handling transactions dealing with dynamic content, object, application, or software. In another embodiment, the app 110 may be designed to run on a social network platform, such as FACEBOOK™ or JUSTSYNC™.

In some embodiments, the system 100 may include code mobile app 110 that resides on a server where the code mobile app 110 maybe downloadable to the mobile communication device 102 from the server computer. As such, the user may perform the customization of the icons 118 remotely from the mobile communication device 102 whereby the information is synchronized either immediately or shortly thereafter. For example, the code mobile app 110 may comprise in part of a browser, such as for use on the mobile communication device 102, (such as an iPhone, Blackberry, or other smart phone) and the full-sized software program may be on a computer, where communications may occur over a network or directly, either wired or wirelessly.

In yet another embodiment, when the code mobile app 110 is downloaded to the mobile communication device 102 from the server, the user may customize the icons 118 that correspond to the coded messages 120, 120′ for use on an actual or virtual keyboard 150 that mimics the keyboard 150 shown in FIGS. 1A & 1C.

In either embodiment, computer executable instruction code 116 readable by processor 104, (i.e. the server's computer processor 104′ or the mobile communication device's processor 104) is operative to launch the code mobile app 110 for managing the incoming electronic transmissions, receiving and transmitting user supplied coded messages 120, 120′ to select message recipients 122.

Referring back to FIG. 1A, mobile communication device 102 includes an activation button 138 positioned on the exterior surface 142 of the device 102 may be selectively depressed to at least one of activate or deactivate transmission of a message 106 to the recipient 108. Activation button 138 may be semi-rigid in order to prevent accidental activation and protect the electronic circuit 144 within. Mobile communication device's exterior surface 142 may also be constructed from semi-rigid or rigid materials, e.g. plastic, resin, and waterproofed to similarly protect the electronic circuit 144 positioned within.

Electronic circuit 144 comprises of a circuit board 146, which includes the various hardware components, e.g. processor 102, communication means 108 and memory means 106 all in electronic communication with each other and positioned thereon. Conventional wires connect the circuit board 146 with the activation button 138. Circuit board 146 may be formed from silicon, fiberglass, Kapton®, Mylar, or other suitable materials that remain stable in a wide range of extreme temperatures that are well known and used in the arts. Preferably, the circuit board 146 is formed from silicon. Electronic circuit 144 may also include an antenna 148 (not shown) positioned thereon that is electronically connected to processor 104 on the circuit board 146 or alternatively imbedded within the processor 104. Electronic circuit 144 is selectively operable via the activation button 138 for preventing false transmissions.

Mobile communication device 102 includes a keyboard 150 inclusive of icons 118, 118′ imprinted on the plurality of programmable buttons 140, 140′. The at least one or more programmable button 140, 140′ may include icons 118, 118′, alphanumeric characters on a physical or virtual key board.

In some embodiments wherein the apparatus 102 does not include the physical programmable button 140, 140′, a user may launch the code mobile 110 via the activation button 138 and access the code mobile app 110 such that when a user selects an icon 116 (e.g., by touching a touchscreen, or selecting it using a pointing device, roller ball, arrow keys, or other controller) from a virtual keyboard 150, the user may use the icons 118, 118′ to transmit his/her coded message 120.

Illustratively, a user may press the icon 118 for “driving” as imprinted on programmable button 140, for which a visible display of the intended coded message 120 “Driving” may be displayed on the mobile communication device's display means 112 for transmission to the select recipients 122, 122′. In this manner, a user may initiate transmission of a coded message 120 to the intended recipients 122, 122′. Similarly, if the user chooses to answer an incoming call, user may press any icon 118 for the programmed message 120 that he/she intends to transmit in response to the caller and it will be transmitted to the sender 128 of the incoming transmission and or other select recipient 122, 122′.

As shown in FIG. 1A, each icon 118 represents a different message, e.g. the icon 118 depicting “a heart” indicates “Love u”, icon 118′ depicting “an airplane,” represents “on a plane or travelling” and the like. An exemplary legend for the icons 118, 118′, 118″ are included in FIG. 1C for ease of reference.

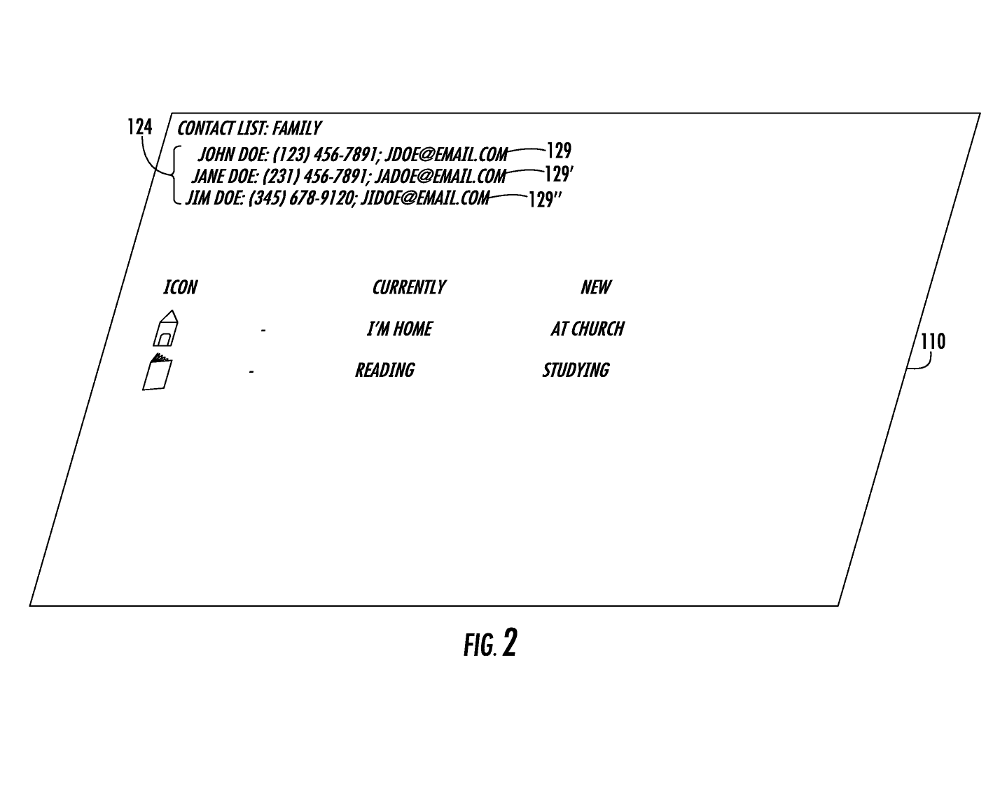

FIG. 2 is an illustrative view of the code mobile app 110 according to an embodiment of the present invention. Code mobile app 110 includes computer executable instruction code 116 executable by the computer processor 102, wherein the computer executable instruction code 116 is configured to: receive selection of at least one icon 118 for transmission of a corresponding coded message 120 to at least one or more message recipients 122, 122′; convert the selected at least one icon 118 into the corresponding coded message 120; display the converted coded message 120 on the mobile communication device's at least one displaying means 112; display list 124 of the at least one or more message recipients 122, 122′ for the converted coded message 120; receive selection of the at least one or more message recipient 122, 122′; transmit the converted coded message 120 to the at least one or more message recipient 122, 122′ and the like.

User may customize the programmable buttons 140, 140′ to correspond to one or more customized messages 120, 120′, via the app 110, which may be accessed on a website or mobile communications device 102, such that when the mobile communication device 102 is in use, and a programmable button 140 is selectively depressed, an electronic signal is formed an the app 110 controls/directs the transmission of the coded message 120 to the message recipient 122. The programmable button 140, 140′ may be made from the semi-rigid materials as the activation button 104 in order to prevent accidental selection and transmission of an inadvertent coded message 120.

App 110 provides user with the ability to change the coded message 120 that corresponds to an icon 118 that is imprinted on a programmable button 140. For example, a priest may modify the coded message for “AT HOME” to mean “AT CHURCH”; and a student may modify the coded message 120 that has an icon 118 for an open book to now represent “STUDYING.” In this manner, the user may customize the coded message 120 for more appropriate expressions of his/her activities.

App 110 also allows the user to identify and/or register select message recipients 122, 122′ to receive his or her coded messages 120. User may also group the message recipients 122, 122′, e.g. Family, Friends, Study Group, Business Partners, etc., based on his/her preferences. Accordingly, the computer executable instruction code 116 of the app 110 are operative to perform any one or more of the following: receive registration information 210 (name, address, telephone number, email address and or other electronic contact information for message recipients 122, 122′); receive at least one coded message 120 to be transmitted to the at least one or more select recipients 122, 122′, wherein the at least one coded message 120 correlates to at least one programmable button 140 of the wireless tracking device 102; and receive at least one or more select recipients 122, 122′ to receive the at least one coded message 120.

In some embodiments, mobile communication device 102 may have one or more icons 112, 112′ or other visual indicators that allows a user to launch and access the coded message app 122 associated with its icon 112.

### Methods

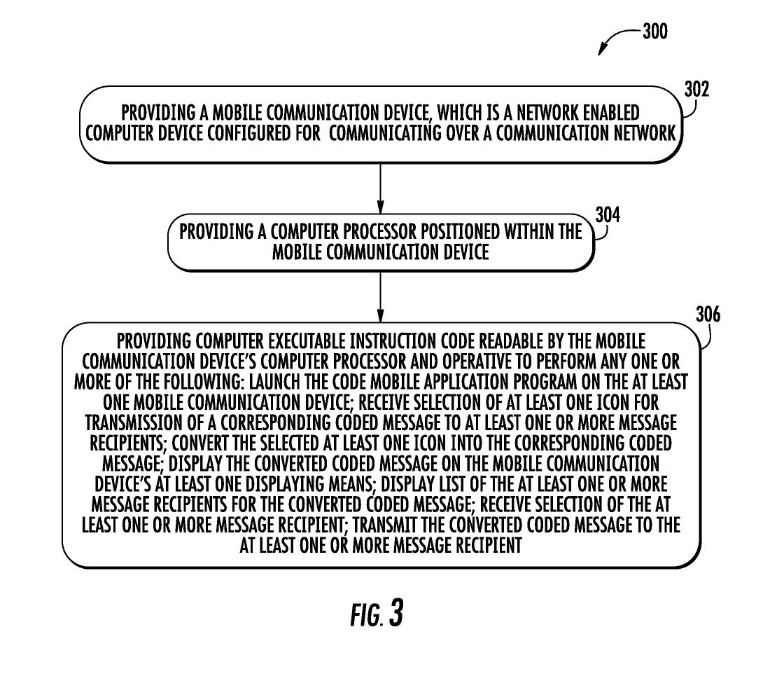

FIG. 3 is a sample flowchart of block diagram of an exemplary method 300 according to one embodiment of the invention. Method 300 comprises of: providing a mobile communication device 102, which is a network enabled computer device configured for communicating over a communication network configured for communicating over a communication network 103 (step 302). Mobile communication device 102 may include at least one displaying means 116 which includes but is not limited to: a LCD screen, a LED screen, or a monitor and the like.

Method 300 further comprises of providing a computer processor 104 positioned within the mobile communication device 102 (step 304). Processor 104 may include any type of computer processors, such as, but not limited to, a central processing unit (CPU), a microprocessor, a video processor, a front end processor, a coprocessor, a single-core processor, a multi-core processor, as well as any known computer processor 104 that's used in the arts.

Method 300 further comprises of providing computer executable instruction code 116 readable by the mobile communication device's computer processor 104 and operative to perform any one or more of the following: launch the code mobile application program 110 on the at least one mobile communication device 102; receive selection of at least one icon 118 for transmission of a corresponding coded message 120 to at least one or more message recipients 122, 122′; convert the selected at least one icon 118 into the corresponding coded message 120; display the converted coded message 120 on the mobile communication device's at least one displaying means 112; display list 124 of the at least one or more message recipients 122, 122′ for the converted coded message 120; receive selection of the at least one or more message recipient 122, 122′; transmit the converted coded message 120 to the at least one or more message recipient 122, 122′ and the like (step 306).

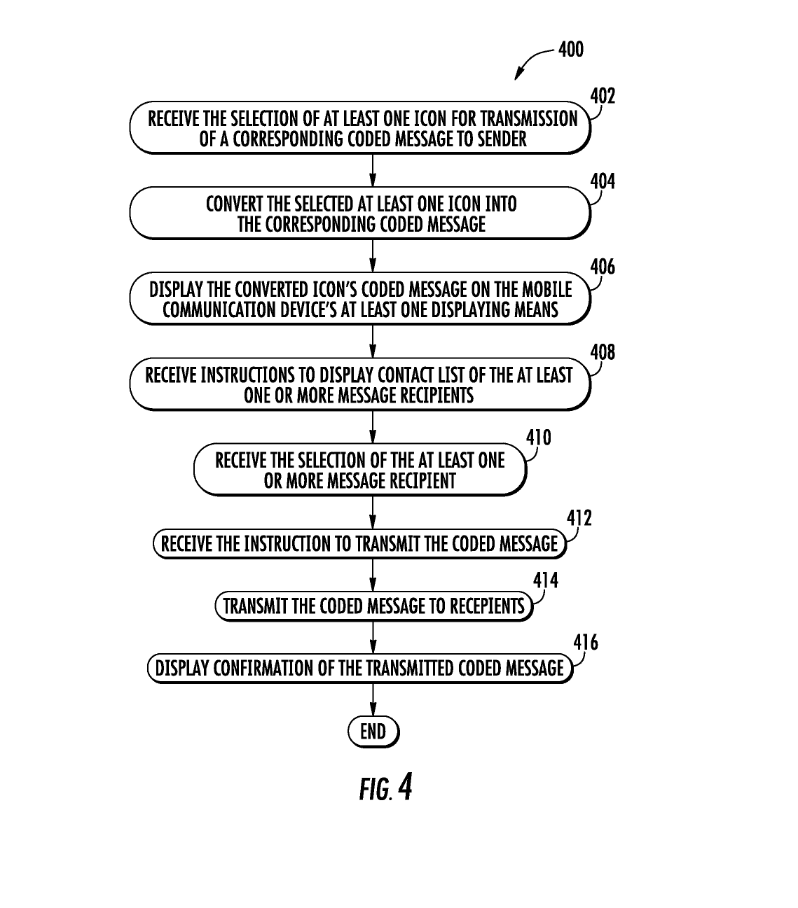

FIG. 4 describes a sample flowchart of a block diagram of an exemplary method 400 of transmitting at least one coded message 120 according to another embodiment. Method 400 comprises of receiving selection of at least one icon 118 for transmission of a corresponding coded message 120 to at least one or more message recipients 122, 122′ (step 402) when the user selectively depresses the programmable button 140 with the icon 118 imprinted thereon. Method 400 further comprises of converting the selected at least one icon 118 into the corresponding coded message 120 (step 404), e.g. if the user selected the at least one icon 118 representative for coded message “I′m Driving,” the icon 118 would be converted and processor 108 causes the activation of the displaying means 112 to display of the converted icon's coded message 120 on the mobile communication device's at least one displaying means 112 (step 406).

In some embodiments user may require the coded message 120 to be published to one or a plurality of message recipients 122, 122′ and as such user may select an expansion of a list of contacts from which the message recipients 122, 122 can be selected. As such, method 400 receives instructions to display contact list of the one or more message recipients 122, 122′ for the converted coded message 120 (step 408); receives the selection of the at least one or more message recipient 122, 122′ (step 410) and method 400 receives the instruction to transmit the coded message 120 (step 412), e.g. receive a “SEND” instruction via a “SEND” button or an equivalent programmable button 140, and transmit the coded message 120 to the at least one or more message recipients 122, 122′ (step 414). In some embodiments, method 400 displays confirmation of the transmitted coded message 120 (step 416).

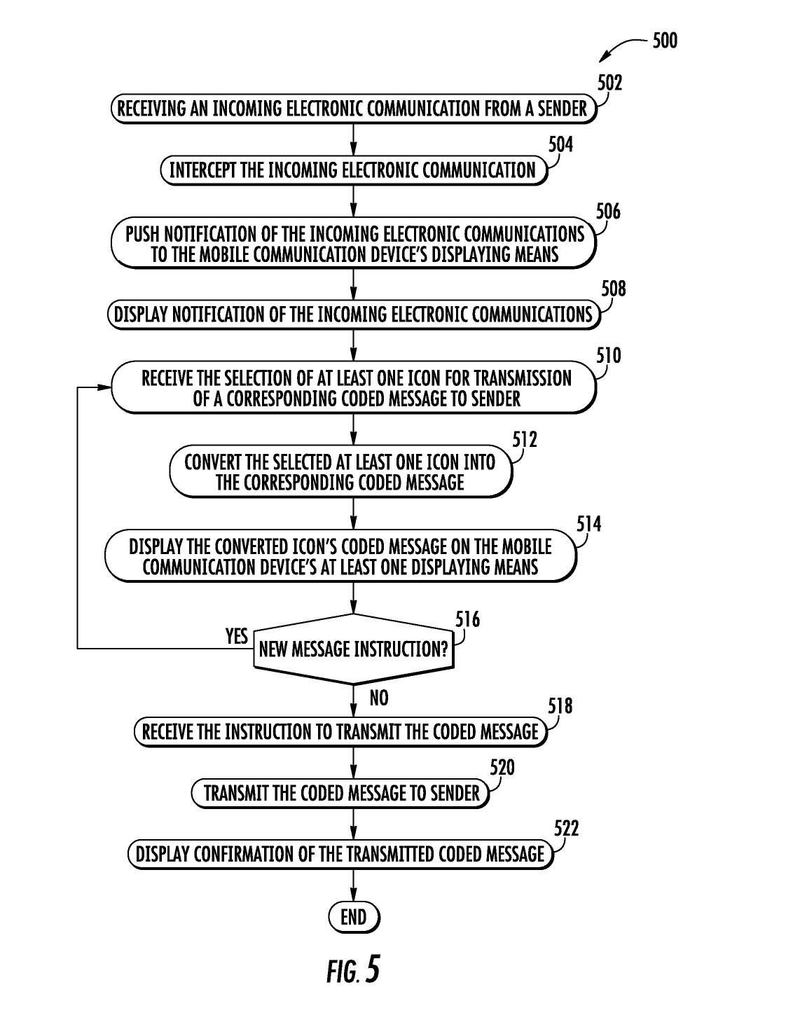

FIG. 5 describes a sample flowchart of a block diagram of an exemplary method 500 of responding to an incoming electronic communication 126. Method 500 comprises of receiving an incoming electronic communication 126 from a sender (step 502) wherein the code mobile app 110 intercepts the incoming electronic communication 126 (step 504) such that it can be responded to via the code mobile app 110 with the possibility of any of the three responses: voice message, coded message 120 or termination of the incoming communication 126, e.g. call.

In either event, the computer executable instruction code 116 push notification of the incoming electronic communications 126 to the mobile communication device's displaying means 112 (step 506), which displays notification of the incoming electronic communications 126 (step 508). If user elects to respond via a coded message, user may choose an icon 118 that corresponds to a coded message 120 of his/her choice by selectively depressing the programmable button 140 with the corresponding icon 118 imprinted thereon. Method 500 receives the selection of at least one icon 118 for transmission of a corresponding coded message 120 to sender 128 (step 510), convert the selected at least one icon 118 into the corresponding coded message 120 (step 512), and display of the converted icon's coded message 120 on the mobile communication device's at least one displaying means 112 (step 514). Here, user may have the opportunity to verify that the coded message 120 displayed is the coded message 120 that user desires to transmit. If not, user may re-select the icon 118 for an alternate coded message 120, in which event app 110 verifies if new message instruction was received (step 516) method 500 returns to (step 510-516). However, if the coded message 120 is correct, user may confirm the transmission by depressing for e.g. a “SEND” or equivalent programmable button 140, and method 500 receives the instruction to transmit the coded message 120 (step 518) and transmit the coded message 120 to sender 128 (step 520). In some embodiments, method 500 displays confirmation of the transmitted coded message 120 (step 522).

### Hardware and Operating Environment

This section provides an overview of example hardware and the operating environments in conjunction with which embodiments of the inventive subject matter can be implemented.

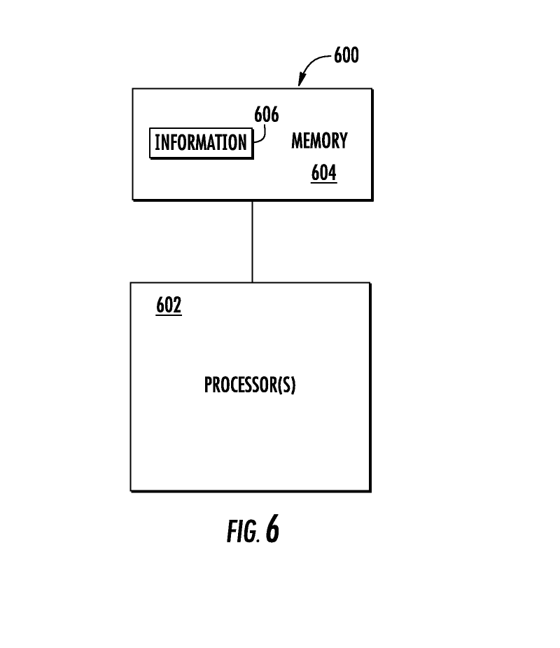

A software program may be launched from a computer readable medium in a computer-based system 100 to execute the functions defined in the software program. Various programming languages may be employed to create software programs designed to implement and perform the methods 300, 400 & 500 disclosed herein. The programs may be structured in an object-orientated format using an object-oriented language such as Java or C++. Alternatively the programs may be structured in a procedure-oriented format using a procedural language, such as assembly or C. The software components may communicate using a number of mechanisms, such as application program interfaces, or inter-process communication techniques, including remote procedure calls. The teachings of various embodiments are not limited to any particular programming language or environment. Thus, other embodiments may be realized, as discussed regarding FIG. 6 below.

FIG. 6 is a block diagram representing an apparatus 600 according to various embodiments. Such embodiments may comprise a computer, a memory system, a magnetic or optical disk, some other storage device, or any type of electronic device or system. The apparatus 600 may include one or more processor(s) 604 coupled to a machine-accessible medium such as a memory 602 (e.g., a memory including electrical, optical, or electromagnetic elements). The medium may contain associated information 604 (e.g., computer program instructions, data, or both) which, when accessed, results in a machine (e.g., the processor(s) 604) performing the activities previously described herein.

The principles of the present disclosure may be applied to all types of computers, systems, and the like, include desktop computers, servers, notebook computers, personal digital assistants, microcomputers, and the like. However, the present disclosure may not be limited to the personal computer.

While the principles of the disclosure have been described herein, it is to be understood by those skilled in the art that this description is made only by way of example and not as a limitation as to the scope of the disclosure. Other embodiments are contemplated within the scope of the present disclosure in addition to the exemplary embodiments shown and described herein. Modifications and substitutions by one of ordinary skill in the art are considered to be within the scope of the present disclosure.

What is claimed is:

1. An apparatus comprising of:
a. a mobile communication device, which is a network enabled computer device configured for communicating over a communication network;
b. at least on icon imprinted on at least one programmable button positioned on an electronic keyboard wherein the icon corresponds to a coded message for transmission to a message recipient;
c. communications means electronically connected to a computer processor positioned within the mobile communication device;
d. computer executable instruction code readable by the computer processor and operative to perform any one or more of the following:
(i) receive selection of at least one icon for transmission of a corresponding coded message to at least one message recipient;
(ii) convert the selected at least one icon into the corresponding coded message;
(iii) display the converted coded message on the mobile communication device's at least one displaying means;
(iv) display list of the at least one message recipient for the converted coded message;
(v) receive selection of the at least one message recipient; or
(vi) transmit the converted coded message to the at least one message recipient.

2. The apparatus of claim 1, wherein the computer executable instruction code readable by the computer processor are further operative to perform any one or more of the following:
(a) activate the mobile communication device for the receipt or transmission of electronic communications;
(b) receive incoming electronic communications from a sender;
(c) push notification of the incoming electronic communications to the mobile communication device's displaying means;
(d) display confirmation of transmission of the coded message; or
(e) respond to the incoming electronic communications in any one or more of the following manner: voice, text or termination of the incoming communication.

3. The apparatus of claim 2, wherein the incoming electronic communications may include any one or more of the following: text, call, or data.

4. The apparatus of claim 2, wherein push notification further comprises notifying the user of the incoming electronic communications by any one or more of the following means: audio, text or graph.

5. The apparatus of claim 1, further comprising of a coded message application comprising of computer executable instruction code readable by the computer processor that are operative to perform any one or more of the following:
(a) launch an application program for transmitting the at least one coded message to the at least one message recipient; or
(b) display a plurality of icons on the mobile communication device's at least one displaying means.

6. The apparatus of claim 5, further comprising a virtual touch-screen keyboard configured to receive the selection of the at least one icon for transmission of the corresponding coded message to the at least one message recipient.

7. The apparatus of claim 1, further comprising of displaying means that includes any one of the following: a liquid crystal display screen, a light emitting diode display, touchpad or touch screen display.

8. The apparatus of claim 1, wherein the communication means are operative to transmit or receive electronic communications.

9. A system comprising of:
a. a mobile communication device, which is a network enabled computer device configured for communicating over a communication network;
b. a computer processor positioned within the mobile communication device;
c. computer executable instruction code readable by the mobile communication device's computer processor and operative to perform any one or more of the following:
(i) receive selection of at least one icon for transmission of a corresponding coded message to at least one message recipient;
(ii) convert the selected at least one icon into the corresponding coded message;
(iii) display the converted coded message on the mobile communication device's at least one displaying means;
(iv) display list of the at least one message recipient for the converted coded message;
(v) receive selection of the at least one message recipient; or
(vi) transmit the converted coded message to the at least one message recipient.

10. The system of claim 9, wherein the computer executable instruction code readable by the computer processor are further operative to perform any one or more of the following:
(f) activate the mobile communication device for the receipt or transmission of electronic communications;
(g) receive incoming electronic communications from a sender;
(h) push notification of the incoming electronic communications to the mobile communication device's displaying means;
(i) display confirmation of transmission of the coded message; or
(j) respond to the incoming electronic communications in any one or more of the following manner: voice, text or termination of the incoming communication.

11. The system of claim 9, wherein the incoming electronic communications may include any one or more of the following: text, call, or data.

12. The system of claim 9, wherein push notification further comprises notifying the user of the incoming electronic communications by any one or more of the following means: audio, text or graph.

13. The system of claim 9, wherein the incoming electronic communications may be responded to by any one or more of the following manner: voice, text or termination of the incoming electronic communications.

14. The system of claim 9, wherein the at least one icon corresponds to at least one programmable button positioned on the mobile communication device.

15. The system of claim 9, further comprising of a coded message application comprising of computer executable instruction code readable by the computer processor that are operative to perform any one or more of the following:
(c) launch an application program for transmitting the at least one coded message to at least one message recipient; or
(d) display a plurality of icons on the mobile communication device's at least one displaying means.

16. The system of claim 9, further comprising a virtual touch-screen keyboard configured to receive the selection of the at least one icon for transmission of the corresponding coded message to the at least one message recipient.

17. A method comprising of:
a. providing a mobile communication device, which is a network enabled computer device configured for communicating over a communication network;
b. providing a computer processor positioned within the mobile communication device;
c. providing computer executable instruction code readable by the mobile communication device's computer processor and operative to perform any one or more of the following:
(i) receive selection of at least one icon for transmission of a corresponding coded message to at least one message recipient;
(ii) convert the selected at least one icon into the corresponding coded message;
(iii) display the converted coded message on the mobile communication device's at least one displaying means;
(iv) display list of the at least one message recipient for the converted coded message;
(v) receive selection of the at least one message recipient; or
(vi) transmit the converted coded message to the at least one message recipient.

18. The method of claim 17, wherein the computer executable instruction code readable by the computer processor are further operative to perform any one or more of the following:
(k) activate the mobile communication device for the receipt or transmission of electronic communications;
(l) receive incoming electronic communications from a sender;
(m) push notification of the incoming electronic communications to the mobile communication device's displaying means; or
(n) display confirmation of transmission of the coded message.

19. The method of claim 18, wherein the incoming electronic communications may include any one or more of the following: text, call, or data.

20. The method of claim 18, wherein the incoming electronic communications may include any one or more of the following: text, call, or data.

21. The method of claim 18, wherein push notification further comprises notifying the user of the incoming electronic communications by any one or more of the following means: audio, text or graph.

22. The method of claim 18, wherein the incoming electronic communications may be responded to by any one or more of the following manner: voice, text or termination of the incoming electronic communications.

23. The method of claim 17, wherein the at least one icon corresponds to at least one programmable button positioned on the mobile communication device.

24. The method of claim 17, further comprising of providing a coded message application comprising of computer executable instruction code readable by the computer processor that are operative to perform any one or more of the following:
(e) launch an application program for transmitting the at least one coded message to at least one message recipient; or
(f) display a plurality of icons on the mobile communication device's at least one displaying means.

25. The method of claim 17, further comprising providing a virtual touch-screen keyboard configured to receive the selection of the at least one icon for transmission of the corresponding coded message to the at least one message recipient.

26. The method of claim 17, further comprising of providing for the response to the incoming communication in any one or more of the following manner: voice, text or termination of the incoming communication.

27. The method of claim 17, further comprising displaying at least one contact information for the sender of the incoming communication.

28. The method of claim 18, further comprising displaying the converted icon's coded message on the at least one display device.

29. The method of claim 17, further comprising receiving selection of at least one message recipient other than the sender of the incoming communication.

30. The method of claim 17, further comprising transmitting the coded message to the selected at least one message recipient.
